(19) United States
(12) Patent Application Publication
(10) Pub. No.: US 2019/0303789 A1
(43) Pub. Date: Oct. 3, 2019

(54) COMPUTER-READABLE RECORDING MEDIUM, LEARNING METHOD, AND LEARNING DEVICE

(71) Applicant: FUJITSU LIMITED, Kawasaki-shi (JP)

(72) Inventors: Takuya Nishino, Atsugi (JP); Ryota Kikuchi, Kawasaki (JP)

(73) Assignee: FUJITSU LIMITED

(21) Appl. No.: 16/362,690

(22) Filed: Mar. 25, 2019

(30) Foreign Application Priority Data
Mar. 30, 2018 (JP) 2018-069153

(51) Int. Cl. G06N 20/00; H04L 29/06; G06F 17/28

(52) U.S. Cl. CPC G06N 20/00; G06F 17/28; H04L 63/1416; H04L 63/145

(57) ABSTRACT

A non-transitory computer-readable recording medium stores a program that causes a computer to execute a process including: inputting input data generated from a plurality of logs, the input data including one or more records that have a plurality of items; generating conversion data by complementing, regarding a target record, included in the input data, in which one or more values in the plurality of items has been lost, at least one of the one or more lost values by a candidate value; and causing a learner to execute a learning process using the conversion data as input tensor, the learner performing deep learning by performing tensor decomposition on input tensor.

### CROSS-REFERENCE TO RELATED APPLICATION

This application is based upon and claims the benefit of priority of the prior Japanese Patent Application No. 2018-069153, filed on Mar. 30, 2018, the entire contents of which are incorporated herein by reference.

### FIELD

The embodiment discussed herein is related to a computer-readable recording medium, a learning method, and a learning device.

### BACKGROUND

In recent years, machine learning in which various kinds of data are used as inputs is performed. If the input data used in machine learning is, for example, data acquired from various machines, in some cases, because the installation location of a machine that acquires data and a timing at which data is acquired vary, an overlap occurs even in a case of the same data. Furthermore, in a case where, for example, a temporal delay occurs or a missing value is generated in data, it is sometimes difficult to appropriately associate or handle these pieces of data. When machine learning is performed on this type of input data, for example, input data in which a missing portion has been complemented is sometimes used. Furthermore, there is a known graph structure learning technology (hereinafter, a device that performs this type of graph structure learning is referred to as “deep tensor”) for enabling to perform deep learning on data having a graph structure.

Patent Document 1: Japanese Laid-open Patent Publication No. 2007-179542

However, when complementing the missing portion, if learning is performed by complementing the missing portion by, for example, not available (NA) or a value that is based on a statistical distribution, as a result, learning is performed by adding the feature value that is associated with the design of the value to be complemented. Consequently, complementing the missing portion needed for machine learning may possibly be an obstruction of the distinction accuracy.

### SUMMARY

According to an aspect of an embodiment, a non-transitory computer-readable recording medium stores a program that causes a computer to execute a process including: inputting input data generated from a plurality of logs, the input data including one or more records that have a plurality of items; generating conversion data by complementing, regarding a target record, included in the input data, in which one or more values in the plurality of items has been lost, at least one of the one or more lost values by a candidate value; and causing a learner to execute a learning process using the conversion data as input tensor, the learner performing deep learning by performing tensor decomposition on input tensor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a learning device according to an embodiment;

FIG. 2 is a diagram illustrating an example of an intrusion into a corporate network and an example of locations in which logs have been acquired;

FIG. 3 is a diagram illustrating an example of a missing pattern in the data acquired from a plurality of machines;

FIG. 4 is a diagram illustrating an example of a candidate value that complements a missing value;

FIG. 5 is a diagram illustrating an example of learning in deep tensor;

FIG. 6 is a diagram illustrating an example of comparing extraction of a partial structure obtained by deep tensor with a decision method of another partial structure;

FIG. 7 is a diagram illustrating an example of comparing the amounts of information contained in partial structures;

FIG. 8 is a diagram illustrating an example of a relationship between the classification accuracy and an amount of information of data combinations;

FIG. 9 is a diagram illustrating an example of an integrated data storage unit;

FIG. 10 is a diagram illustrating an example of a replication data storage unit;

FIG. 11 is a diagram illustrating an example of generating replication data;

FIG. 12 is a flowchart illustrating an example of a learning process according to the embodiment;

FIG. 13 is a flowchart illustrating an example of a distinguishing process according to the embodiment; and

FIG. 14 is a diagram illustrating an example of a computer that executes a learning program.

### DESCRIPTION OF EMBODIMENTS

Preferred embodiments of the present invention will be explained with reference to accompanying drawings. The disclosed technology is not limited to the present invention. Furthermore, the embodiments described below may also be used in any appropriate combination as long as the embodiments do not conflict with each other.

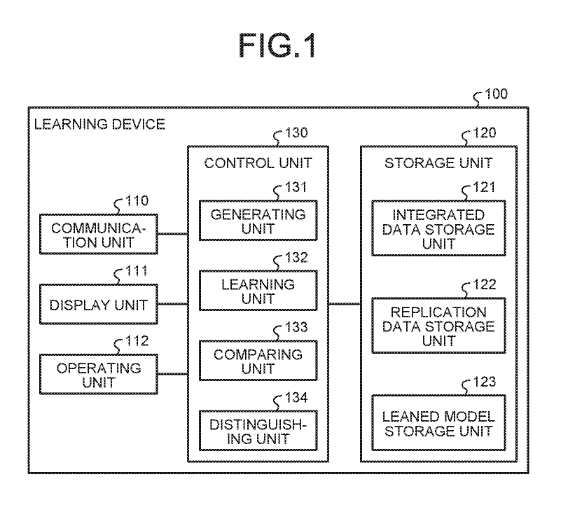

FIG. 1 is a block diagram illustrating an example of a configuration of a learning device according to an embodiment. A learning device 100 illustrated in FIG. 1 inputs input data generated from a plurality of logs in each of which a record that has a plurality of items is used as a unit of data. The learning device 100 generates conversion data by complementing, regarding a complement target record in which one of the items of the input data has been lost, at least one of the lost values by a candidate value. The learning device 100 allows a learning machine, which performs deep learning by performing tensor decomposition on input tensor data, to learn the conversion data. Consequently, the learning device 100 can suppress the degradation of the distinction accuracy due to the complement.

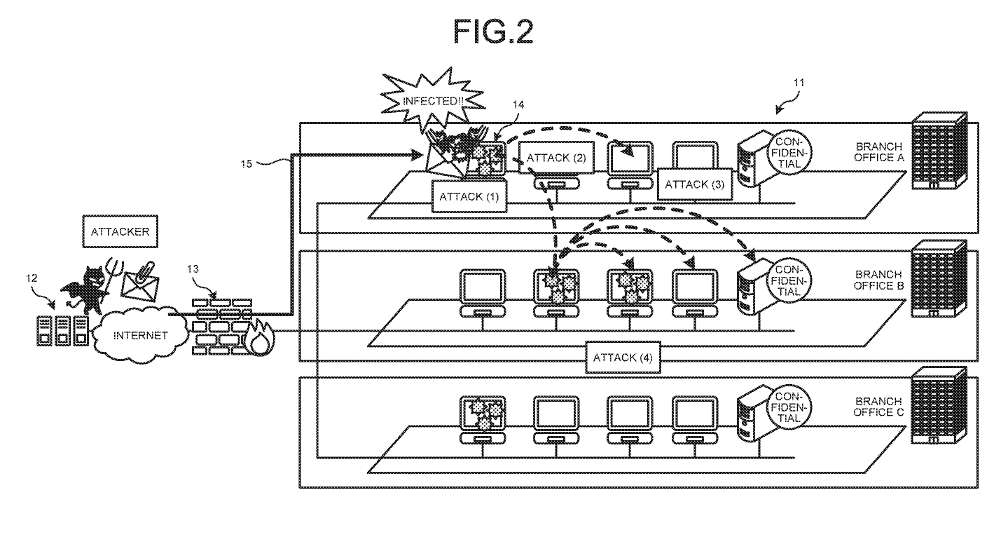

First, acquiring of logs and a loss of data will be described with reference to FIG. 2 to FIG. 4. FIG. 2 is a diagram illustrating an example of an intrusion into a corporate network and an example of locations in which logs have been acquired. FIG. 2 indicates acquisition locations of logs in a case where a certain corporate network 11 has been attacked from an external attacker. The attacker sends malware from, for example, an attack server 12 via a firewall 13, to a terminal 14 in the corporate network 11. The malware performs an unauthorized action based on the terminal 14 that has been contaminated. The unauthorized action is performed in the corporate network 11, such as the other terminals or the like, as indicated by, for example, attacks (1) to (4) illustrated in FIG. 2. The malware leaves, at the time of its action, traces of the operations specific to the action of the attacker or the flow of a series of communication. This type of action is recorded in various logs, such as logs of the firewall 13, event logs of the terminal 14 or the other terminals attacked from the terminal 14, or logs of communication captured in an intrusion path 15.

However, it is difficult to distinguish the unauthorized communication or action histories of malware from normal communication or operation histories. Furthermore, it is difficult to determine whether communication is unauthorized communication based on only a specific history, such as each of the individual logs or the like; therefore, conventionally, specialists comprehensively perform determination based on each of the logs. In order to implement the comprehensive determination, in the embodiment, machine learning is performed, as combined graph structure data, on a large number of logs in which limited information has been recorded, and normal operations and the actions of the attacker are classified. As the logs, logs of establishment behaviors of communication and logs of actions of processes, which are typical patterns for attack actions, are present and information on at least these two types of logs are regarded as the graph structure data. Here, an establishment behavior of communication is expressed in, for example, a log related to communication. Furthermore, the action of processes, i.e., the action of command operations remotely performed, are expressed in the processes or the event logs.

In this way, if logs have been acquired from a plurality of machines, in each of the logs, the acquisition locations, temporal delays, and granularity are different among machines. Consequently, in the integrated data obtained by integrating each of the logs, in some cases, logs of the same action is recorded in a plurality of records. Furthermore, in some cases, regarding the data in the logs, even if the same type of machines, if the machines are different units, one of logs is sometimes missed due to a failure or the like. Namely, in the integrated data, in some cases, a record in which one of values in items has been lost. Furthermore, in a description below, a loss of one of values in the items is sometimes referred to as a miss and the value thereof is sometimes referred to as a missing value.

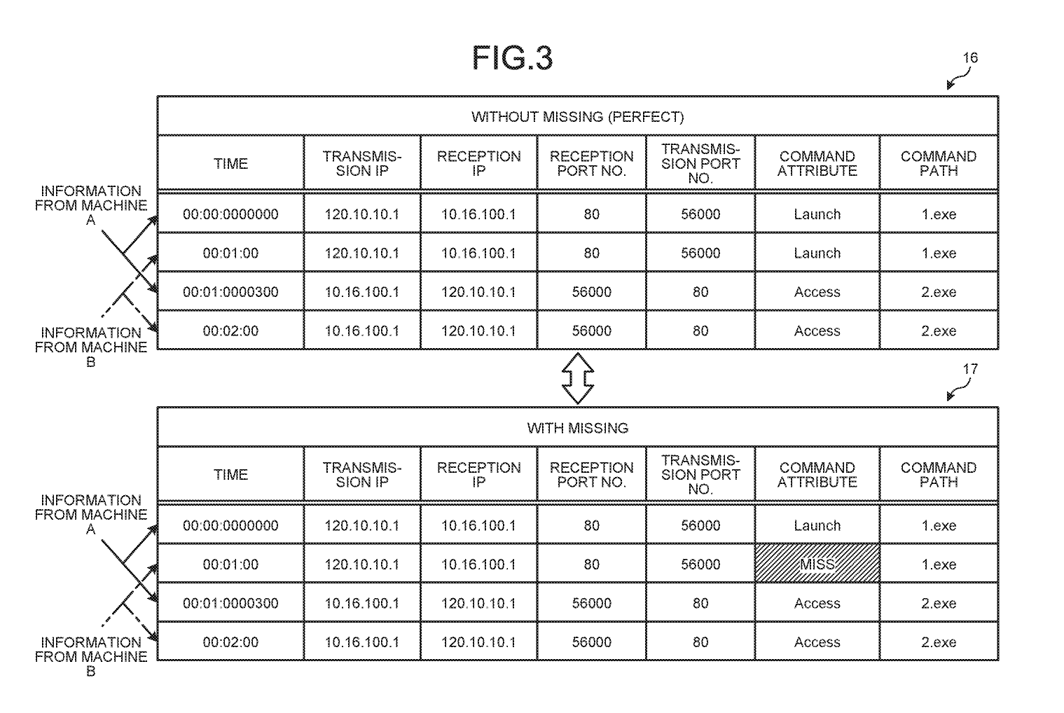

FIG. 3 is a diagram illustrating an example of a missing pattern in the data acquired from a plurality of machines. Data 16 illustrated in FIG. 3 is an example of data that has been obtained by integrating information (logs) from a machine A and a machine B and that does not have not a miss. In contrast, data 17 is an example of data that has been obtained by integrating information (logs) from the machine A and the machine B and the example of a case in which, data in the item “command attribute” has been missed in the record on the second line because, for example, the machine B is broken down. In the case of such a missing pattern, it is easy to complement (associate) a partial missing if the relationship between each of the previous and subsequent records is clear; however, the relationship between the previous and subsequent records is sometimes unclear due to the connection with the other logs. An example of an unclear case includes a case in which a large amount of communication is performed by changing various kinds of information in a short period of time, such as a case of port scan, a distributed denial of service (DDoS) attack, or the like. In this case, it is difficult to determine whether complementing a partial missing is really correct. Furthermore, it is assumed that, in the data 16 and the data 17, the first and the second lines and the third and the fourth lines are the logs based on each of the same actions. Then, in the example of the data 16 and the data 17, on the first and the second lines and on the third and the fourth lines, the pieces of temporal granularity are different. In this way, it is sometimes difficult to simply associate the logs of the machines each having different granularity.

To complement a single miss as indicated by the data 17, it is conceivable to perform complement by a value that is based on a statistical distribution by using a multiple assignment method, a multivariate imputation by chained equations (MICE), or the like. However, if a missing value is regarded as an appropriate value due to a frequently appeared value and has been complemented by the value that is frequently appeared, in a rare case, such as an attack by malware, the result is led to the frequency of appearance of normal data and thus an appropriate complement is not performed. Furthermore, in these complement methods, various hypotheses or techniques are present in a mixed manner and it is thus difficult to define that a certain hypothesis is valid for all of the pieces of data. In contrast, in the embodiment, by using a deep tensor with respect to the data in which a miss has been appropriately complemented, generalization is improved by learning an optimum combination that is present in a background at the time of, for example, detection of an attack, such as malware, performed by a remote operation.

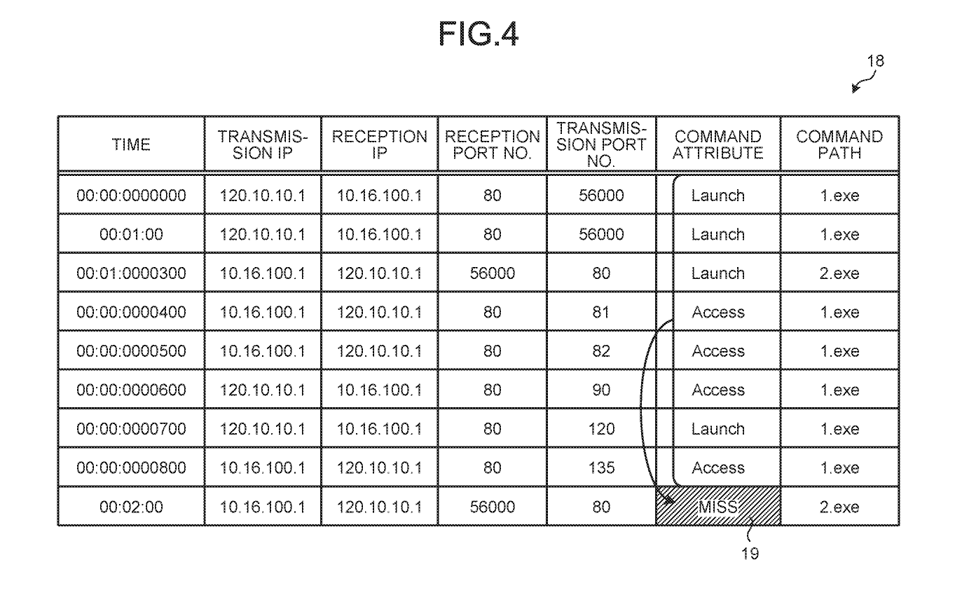

FIG. 4 is a diagram illustrating an example of a candidate value that complements a missing value. In data 18 illustrated in FIG. 4, the item “command attribute” on the ninth line in the record is a missing value 19. Because the missing value 19 is simply missed, a single appropriate pattern is present in the data 18. In the missing value 19, the values indicated by “Launch” and “Access” on the first to the eighth lines in the same item in the record become the candidate values to be complemented. Namely, the missing value 19 can be complemented one of the “Launch” and “Access” on the first to the eighth lines in the records.

In the following, deep tensor and an amount of information of a partial structure will be described. Deep tensor mentioned here is deep learning performed by using tensors (graph information) as an input and automatically extracts, while performing learning of neural networks, partial graph structures (hereinafter, also referred to as partial structures) that contribute distinction. This extracting process is implemented by learning, while performing learning of neural networks, parameters of tensor decomposition of the input tensor data.

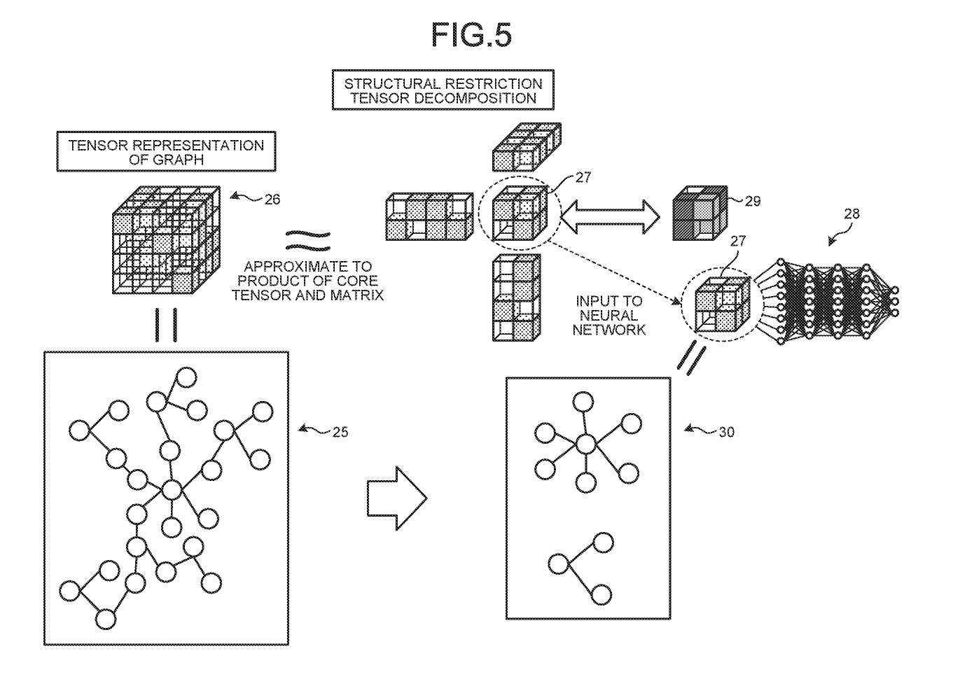

FIG. 5 is a diagram illustrating an example of learning in deep tensor. As illustrated in FIG. 5, a graph structure 25 representing the entire of certain graph structure data can be represented as a tensor 26. Furthermore, the tensor 26 can be approximated to the product of a core tensor 27 and the matrix by structural restriction tensor decomposition. In deep tensor, deep learning is performed by inputting the core tensor 27 to a neural network 28 and performs optimization using an extended error back propagation method so as to approach a target core tensor 29. At this time, if the core tensor 27 is represented by a graph, a graph 30 representing a partial structure in which the features have been condensed. Namely, deep tensor can automatically learn an important partial structure based on the core tensor from the entire graph.

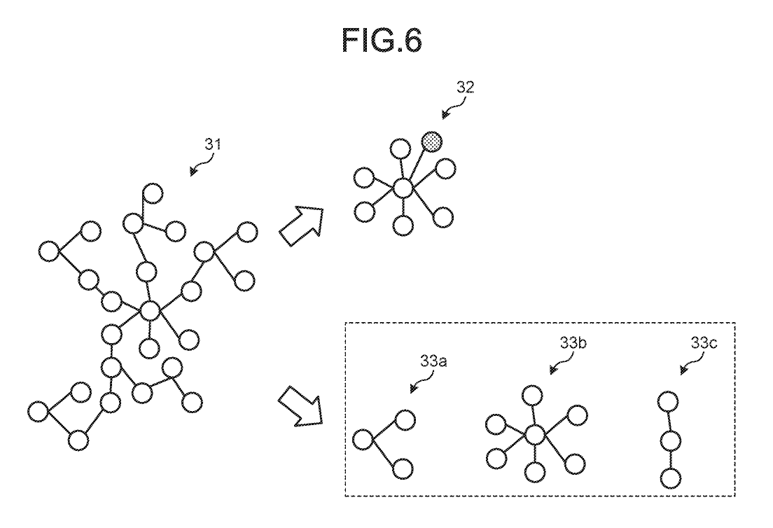

FIG. 6 is a diagram illustrating an example of comparing extraction of a partial structure obtained by deep tensor with a decision method of another partial structure. In FIG. 6, a graph 31 that corresponds to the original graph is compared with in a case where a partial structure is decided by performing conversion based on a specific relationship, such as an adjacent relationship, and is compared with in case where a partial structure is extracted by using deep tensor. In a case where a partial structure is decided based on a specific relationship, learning is performed such that, for example, if the number of combinations of data is increased with respect to a partial structure 32, which has been decided that the other six nodes attached at the center of a certain node is the feature, the important thing is that the other seven or eight nodes are attached to the partial structure 32. Namely, in the partial structure 32 that is based on the specific relationship, because a feature value (amount of information) varies, the classification result accordingly varies.

In contrast, in a case where an arbitrary partial structure that contributes classification is extracted by using deep tensor, partial structures 33a, 33b, and 33c that contribute classification are extracted regardless of the assumption that neighboring nodes are classified. At this time, even if a new piece of input data is input to deep tensor, if a partial structure that contributes classification is not found, the partial structures 33a, 33b, and 33c are invariable with respect to the input data. Namely, in deep tensor, it is possible to extract a partial structure that contributes classification without assuming a specific connection.

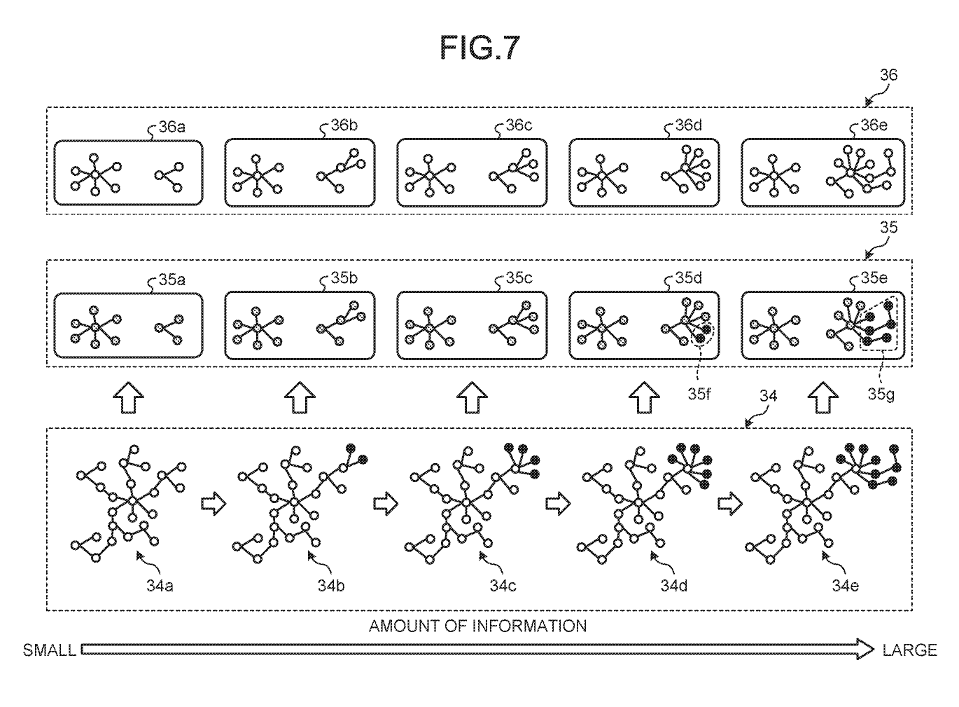

FIG. 7 is a diagram illustrating an example of comparing the amounts of information contained in partial structures. In FIG. 7, a partial structure group 35 that performs extraction from an original data group 34 by using deep tensor is compared with a partial structure group 36 that is decided at the time of design. In the original data group 34, an amount of information is sequentially increased from data 34a to data 34e. In the partial structure group 35, the partial structures, i.e., from a partial structure 35a to a partial structure 35e, are the partial structures that have been extracted from the data 34a to data 34e, respectively. In the partial structure group 35, a partial structure is added to each of the partial structures, i.e., from the partial structure 35a to the partial structure 35e. At this time, if it is assumed that a partial structure 35f and a partial structure 35g have been added but are not important, it can be said that the partial structures subsequent to the partial structure 35d do not contribute the accuracy.

In contrast, in the partial structure group 36, the partial structures, i.e., from a partial structure 36a to a partial structure 36e, are the partial structures that have been extracted from the data 34a to data 34e, respectively. In the partial structure group 36, a partial structure is added to each of the partial structures, i.e., from the partial structure 36a to the partial structure 36e. At this time, because the partial structures, i.e., from a partial structure 36b to a partial structure 36e, have acquired all of the pieces of information about the variations starting from the partial structure 36a, an amount of noise is thus increased. Namely, in the partial structure 36d and the partial structure 36e, the partial structure 35f and the partial structure 35g, respectively, that have been added but are not important become noise.

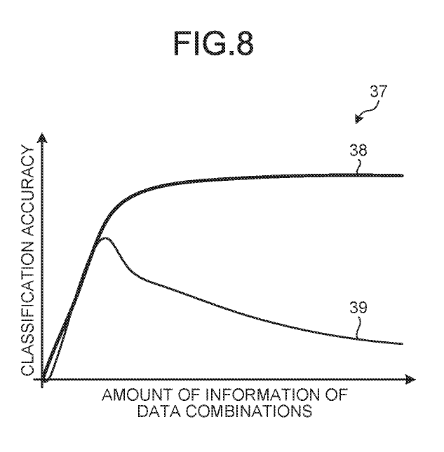

FIG. 8 is a diagram illustrating an example of a relationship between the classification accuracy and an amount of information of data combination. A graph 37 illustrated in FIG. 8 indicates, by using a graph 38 and a graph 39, the relationship between the classification accuracy and an amount of information in the partial structure group 35 that has been extracted by using deep tensor and an amount of information in the partial structure group 36 that is decided at the time of design. As indicated by the graph 38, in the partial structure group 35, even if an amount of information on the combination is increased, the classification accuracy is not decreased and maintains a certain level. Here, the amount of information of the combination is set such that the region in which complement is to be performed from among the combinations is gradually increased and stopped at the maximum level of the evaluation accuracy (classification accuracy). Namely, in deep tensor, because optimization is performed on the partial structure that contributes classification, an appropriate complement region can thus be obtained. Furthermore, as indicated by the graph 38, the complement pattern has been optimized when the result does not vary at all even if a complement pattern is changed (even if an amount of information on combination is increased).

In contrast, as indicated by the graph 39, in the partial structure group 36, if an amount of information on combination is increased, the classification accuracy is reduced caused by noise. Namely, in the partial structure group 36, because the result varies depending on an assumption or an algorithm, the assumption that the result does not vary at all does not hold even if a complement pattern is changed (even if an amount of information on combination is increased).

In this way, in deep tensor, it is possible to automatically extract, from the original large amount of input data, a core tensor in which the features have been condensed. At this time, because the core tensor is selected as the result of maximizing the detected classification accuracy, it is thus possible to automatically extract a partial graph structure that contributes classification. Namely, in the case of using the partial structure group 36 that is decided at the time of design, if an amount of information is increased, the classification accuracy is not increased because learning is not progressed due to large number of useless combinations. In contrast, in deep tensor, because presence or absence of noise is not concerned as long as a needed partial structure can be extracted, learning can be progressed even if the number of combinations is increased.

In the following, a configuration of the learning device 100 will be described. As illustrated in FIG. 1, the learning device 100 includes a communication unit 110, a display unit 111, an operating unit 112, a storage unit 120, and a control unit 130. Furthermore, the learning device 100 may also include, in addition to the functioning units illustrated in FIG. 1, various functioning units included in a known computer, for example, functioning units, such as input devices and audio output device.

The communication unit 110 is implemented by, for example, a network interface card (NIC), or the like. The communication unit 110 is a communication interface that is connected to another information processing apparatus in a wired or wireless manner via a network (not illustrated) and that manages communication of information with other information processing apparatuses. The communication unit 110 receives, for example, training data used for the learning or new data of distinction target from another terminal. Furthermore, the communication unit 110 sends the learning result or the distinguished result to the other terminal.

The display unit 111 is a display device for displaying various kinds of information. The display unit 111 is implemented by, for example, a liquid crystal display or the like as the display device. The display unit 111 displays various screens, such as display screens, that are input from the control unit 130.

The operating unit 112 is an input device that receives various operations from a user of the learning device 100. The operating unit 112 is implemented by, for example, a keyboard, a mouse, or the like as an input device. The operating unit 112 outputs, to the control unit 130, the operation input by a user as operation information. Furthermore, the operating unit 112 may also be implemented by a touch panel or the like as an input device, or, alternatively, the display unit 111 functioning as the display device and the operating unit 112 functioning as the input device may also be integrated as a single unit.

The storage unit 120 is implemented by, for example, a semiconductor memory device, such as a random access memory (RAM) or a flash memory, or a storage device, such as a hard disk or an optical disk. The storage unit 120 includes an integrated data storage unit 121, a replication data storage unit 122, and a learned model storage unit 123. Furthermore, the storage unit 120 stores therein information that is used for the process performed in the control unit 130.

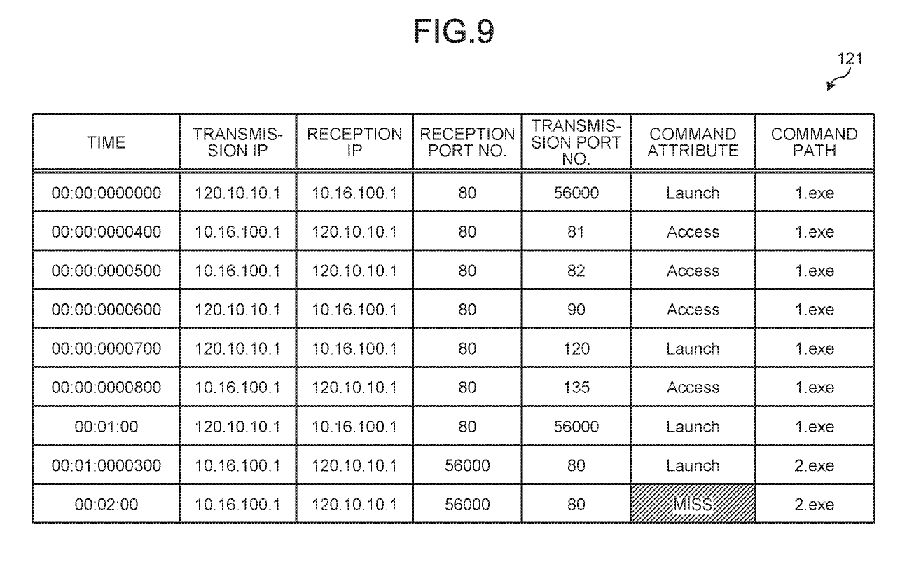

The integrated data storage unit 121 stores therein integrated data that is obtained by integrating the acquired training data. FIG. 9 is a diagram illustrating an example of the integrated data storage unit. As illustrated in FIG. 9, the integrated data storage unit 121 has items, such as “time”, “transmission IP”, “reception IP”, “reception port No”, “transmission port No”, “command attribute”, and “command path”.

The “time” is information indicating the time at which log data of each of the integrated records was acquired. The “transmission IP” is information indicating an IP address of, for example, a server or the like that performs a remote operation. The “reception IP” is information indicating an IP address of, for example, a personal computer or the like that is subjected to the remote operation. The “reception port No” is information indicating a port number of, for example, the server or the like that performs the remote operation. The “transmission port No” is information indicating a port number of, for example, the personal computer or the like that is subjected to the remote operation. The “command attribute” is information indicating the attribute of a started up command in, for example, the personal computer or the like that is subjected to the remote operation. The “command path” is information indicating a started up command path, such as an execution file name, in, for example, the personal computer or the like that is subjected to the remote operation. Furthermore, in the integrated data storage unit 121, the missing value is represented by “miss”.

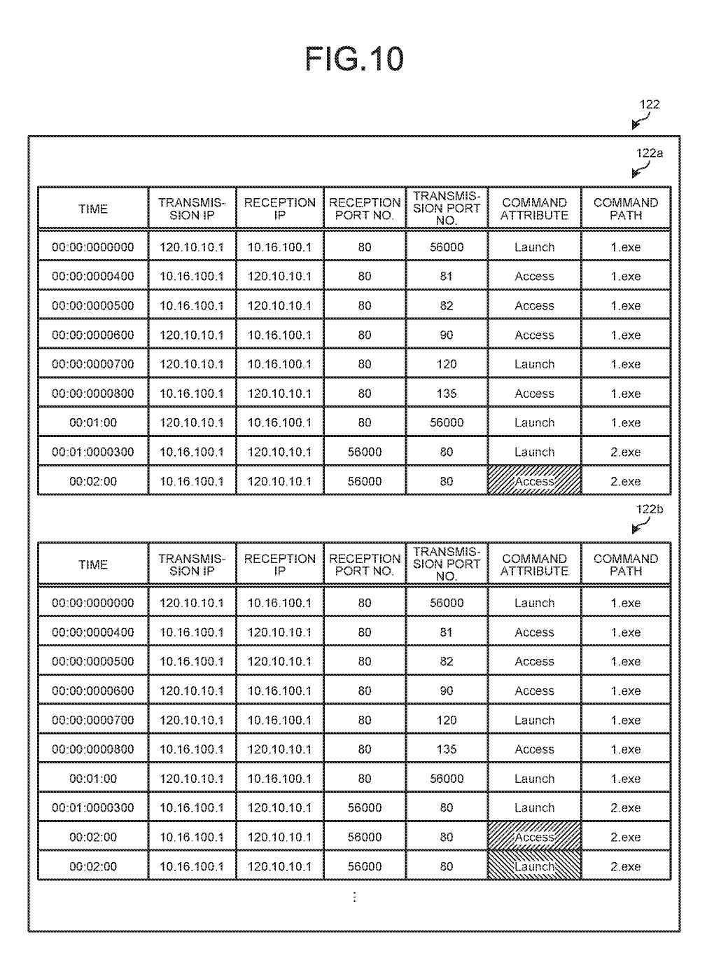

A description will be given here by referring back to FIG. 1. The replication data storage unit 122 stores replication data obtained by substituting (copying) a candidate value of a missing value for the complement target record of the missing value. FIG. 10 is a diagram illustrating an example of a replication data storage unit. As illustrated in FIG. 10, the replication data storage unit 122 has replication data 122a obtained by sequentially arranging each of the records of, for example, the integrated data in time order and by copying the candidate value of the missing value to the missing cell in the complement target record. Furthermore, the replication data storage unit 122 has replication data 122b obtained by replicating a complement target record by a single line and copying each of the two type of candidate values together with the original complement target record. Namely, if the number of candidate values of the missing values is represented by m, the replication data storage unit 122 has consequently replication data 122m in which the complement target record is replicated by the number of (m−1) lines and each of the candidate values is copied.

The replication data 122m has the item, such as “time”, “transmission IP”, “reception IP”, “reception port No”, “transmission port No”, “command attribute”, and “command path”. Furthermore, each of the items are the same as that included in the integrated data storage unit 121; therefore, the description thereof will be omitted.

A description will be given here by referring back to FIG. 1. The learned model storage unit 123 stores therein a learned model that has been obtained by performing deep learning on the replication data, i.e., the conversion data in which a missing value has been complemented. The learned model stores therein, for example, various parameters (weighting factors) of neural networks, a method of tensor decomposition, and the like.

The control unit 130 is implemented by, for example, a central processing unit (CPU), a micro processing unit (MPU), or the like executing, in a RAM as a work area, the program that is stored in an inner storage device. Furthermore, the control unit 130 may also be implemented by, for example, an integrated circuit, such as an application specific integrated circuit (ASIC), a field programmable gate array (FPGA), or the like. The control unit 130 includes a generating unit 131, a learning unit 132, a comparing unit 133, and a distinguishing unit 134 and implements or performs the function or the operation of the information processing described below. Furthermore, the internal configuration of the control unit 130 is not limited to the configuration illustrated in FIG. 1 but may also be another configuration as long as the information processing, which will be described later, is performed.

The generating unit 131 acquires learning purpose training data from another terminal via, for example, the communication unit 110. Namely, the generating unit 131 is an example of an input unit that inputs input data generated from a plurality of logs in each of which a record that has a plurality of items is used as a unit of data. The generating unit 131 generates integrated data obtained by integrating the acquired training data. The generating unit 131 generates the integrated data obtained by each of the pieces of data as indicated by, for example, the data 17 that is based on the information acquired from the machine A and the machine B illustrated in FIG. 3. At this time, the generating unit 131 sequentially arranges, for example, each of the records in time order. The generating unit 131 stores the generated integrated data in the integrated data storage unit 121.

The generating unit 131 specifies a complement target record from the generated integrated data. Regarding the column of the missing value in the specified complement target record, the generating unit 131 extracts a candidate value from another record. If it is assumed that, for example, the number of extracted candidate values is m, the generating unit 131 replicates the extracted complement target records by the number of (m−1) lines to the maximum. Namely, the generating unit 131 replicates the complement target records by the number of complement target records insufficient for the candidate values. Here, the replication of the complement target records is sequentially performed from n=0 to n=m and then each of the associated pieces of replication data are generated. Furthermore, regarding the candidate value, if candidates for values that can be set in the item have been determined, the set values with a plurality of types that have previously been set may also be used.

The generating unit 131 generates the replication data by substituting, i.e., copying, each of the candidate values for, i.e., to, the cells related to the complement target records corresponding to the missing portions. At this time, if it is assumed that the number of replication complement target records is n lines, the generating unit 131 sequentially generates m pieces of replication data in the order from n=0. Furthermore, in a case of n=0 is a case in which a complement value is copied to the cell by the number of cells corresponding to the number of missing portions without replicating the complement target record. When copying a candidate value, the generating unit 131 copies the candidate value extracted from another record in the order in which the number of items whose value is matched with the value included in the item associated with the other record from among the items in each of which a complement target record is not missed. Namely, the generating unit 131 generates the replication data by copying the candidate value in the order in which the value of each of the items in the other record is similar to that in the complement target record. Furthermore, the generating unit 131 may also generate the replication data by sequentially copying the candidate values from the other record positioned at the most recent time of the complement target record. Furthermore, the generating unit 131 generates, only at the first time, the replication data obtained by replicating the complement target records by the number of n lines and the replication data obtained by replicating by the number of n+1 lines.

The generating unit 131 stores the generated replication data in the replication data storage unit 122. Furthermore, if n is increased, the generating unit 131 stores, in the replication data storage unit 122, the generated replication data each time. Namely, in the replication data storage unit 122, the replication data is sequentially stored starting from n=0. Furthermore, if there is a plurality of cells corresponding to missing portions associated with the complement target records, the complement may also be performed by copying the candidate value to at least one of the missing portion cells.

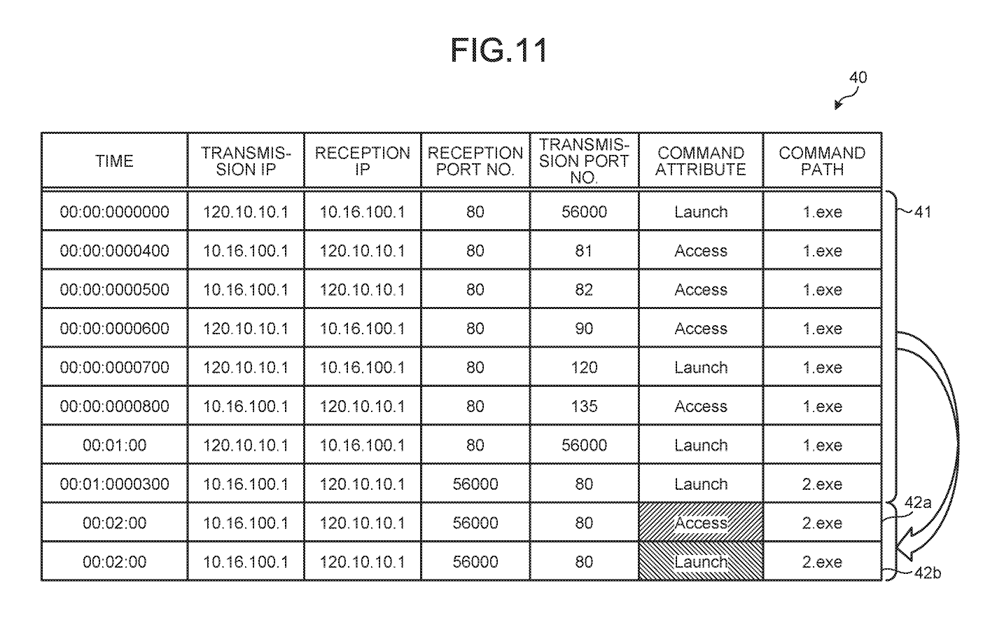

In the following, generating the replication data will be described with reference to FIG. 11. FIG. 11 is a diagram illustrating an example of generating replication data. In the example of replication data 40 illustrated in FIG. 11, regarding the line of the column of the item “command attribute” that is the column of the missing values of the complement target records, the generating unit 131 extracts the candidate values of “Launch” and “Access” from the item “command attribute” in the record group 41. Because the number of candidate value of m is two, the generating unit 131 replicates a single line of the complement target record and generates complement target records 42a and 42b by copying the candidate value to each of the complement target records.

After having generated the replication data, the generating unit 131 divides the generated replication data in order to perform cross-validation. The generating unit 131 generates the learning purpose data and the evaluation purpose data by using, for example, K-fold cross-validation leave-one-out cross-validation (LOOCV). Furthermore, if an amount of training data is small and if an amount of replication data is also small, the generating unit 131 may also verify whether correct determination has been performed by using the replication data that has been used for the learning. The generating unit 131 outputs the generated learning purpose data to the learning unit 132. Furthermore, the generating unit 131 outputs the generated evaluation purpose data to the comparing unit 133.

In other words, regarding the complement target record in which one of values of the items of input data has been lost, the generating unit 131 generates conversion data obtained by complementing at least one of the lost values by a candidate value. Furthermore, the generating unit 131 generates complemented conversion data by using, in the item in which the value of the complement target record has been lost, the values having a plurality of types of records in which the value of the same item is not lost as the candidate value and by copying one of the values from among the subject candidate values. Furthermore, the generating unit 131 generates conversion data by sequentially arranging a plurality of records including the complement target record in time order, by replicating the complement target records by the number of the complement target records that are insufficient for the number of candidate values, and by copying each of the candidate values to the corresponding complement target records. Furthermore, the generating unit 131 generates the conversion data by sequentially copying each of the candidate values to the associated complement target records, in the order in which, from among the items in each of which the value of the complement target record is not lost, the number of items in each of which the value is matched with the item associated with the record that has the candidate value. Furthermore, the generating unit 131 generates the conversion data by sequentially copying each of the candidate values to the associated complement target records in the order of the most recent time. Furthermore, the generating unit 131 generates the conversion data by using, as the candidate values, in the item in which the value of the complement target record has been lost, set values that have a plurality of types and that are previously set and by copying one of the values from among the candidate values.

A description will be given here by referring back to FIG. 1. If the learning purpose data is input from the generating unit 131, the learning unit 132 learns the learning purpose data and generates a learned model. Namely, the learning unit 132 performs tensor decomposition on the learning purpose data and generates a core tensor (partial graph structure). The learning unit 132 obtains an output by inputting the generated core tensor to a neural network. The learning unit 132 learns a parameter of tensor decomposition such that an error of the output value is decreased and the determination result is increased. Flexibility is present in tensor decomposition, an example of the parameter of tensor decomposition includes a combination of a decomposition model, constraint, an optimization algorithm, and the like. An example of the decomposition model is canonical polyadic (CP) decomposition or Tucker decomposition. An example of constraints includes orthogonal constraints, sparse constraints, smooth constraints, nonnegative constraints, or the like. An example of the optimization algorithm includes alternating least square (ALS), higher order singular value decomposition (HOSVD), higher order orthogonal iteration of tensors (HOOI), and the like. In deep tensor, tensor decomposition is performed under the constraint in which the “determination result is increased”.

When the learning unit 132 has completed the learning of learning purpose data, the learning unit 132 stores the learned model in the learned model storage unit 123. At this time, in the learned model storage unit 123, both the learned model associated with the number of replication lines n of the replication data and the learned model associated with the number of replication lines n+1 are arranged to be stored. Namely, the learning unit 132 generates, only at the first time, two learned models, i.e., the learned model associated with the number of replication lines n and the learned model associated with the number of replication lines n+1. The learning unit 132 moves, in a step at the number of replication lines of n=1 and the subsequent steps, the learned model associated with the previous number of replication lines n+1 to the learned model associated with the number of replication lines n and generates the learned model that is associated with the newly learned number of replication lines n+1. Furthermore, regarding the neural network, various kinds of neural networks, such as a recurrent neural network (RNN), may be used. Furthermore, regarding the learning method, various kinds of methods, such as error back-propagation method, may be used.

In other words, the learning unit 132 allows a learning machine, which performs tensor decomposition on the input tensor data and performs deep learning, to learn the conversion data (replication data). Furthermore, the learning unit 132 generates a first learned model that has learned the conversion data, out of the generated conversion data (replication data), that is obtained by replicating the complement target record by the number of n lines and by complementing the candidate values.

Furthermore, the learning unit 132 generates a second learned model that has learned the conversion data, out of the conversion data (replication data), that is obtained by replicating the complement target record by the number of n+1 lines and by complementing the candidate values.

If learning of learning purpose data has been completed in the learning unit 132, the comparing unit 133 refers to the learned model storage unit 123 and compares, by using the evaluation purpose data input from the generating unit 131, the classification accuracy of the evaluation purpose data. Namely, the comparing unit 133 compares the classification accuracy of the evaluation purpose data in a case where the learned model associated with the number of replicated n lines with the classification accuracy of the evaluation purpose data in a case where the learned model associated with the replicated n+1 lines.

The comparing unit 133 determines, as a result of comparison, whether the classification accuracy of the replicated n lines is substantially the same as the classification accuracy of the replicated n+1 lines. Furthermore, comparing the classification accuracy may also be determined based on whether the compared classification accuracy is the same. If the comparing unit 133 determines that the classification accuracy of the replicated n lines is not substantially the same as the classification accuracy of the replicated n+1, the comparing unit 133 instructs the generating unit 131 to increment the number of replication lines n and generates the next replication data. If the comparing unit 133 determines that the classification accuracy of the replicated n lines is substantially the same as the classification accuracy of the replicated n+1, the comparing unit 133 stores, in the learned model storage unit 123, the learned model associated with the replicated n lines at that time, i.e., the learned model of the number of replication lines n, and the n+1 pieces of complement values associated with the subject number of replication lines n. Namely, the learned model of the number of replication lines n at that time is in a state in which the classification accuracy does not vary.

In other words, the comparing unit 133 compares the classification accuracy of the first learned model and the second learned model by using the evaluation purpose data that is based on the generated conversion data. The comparing unit 133 outputs the first learned model and n+1 pieces of complement values that have been complemented to the complement target record in a case where the n is increased until the compared pieces of classification accuracy become equal.

After having generated the learned model, the distinguishing unit 134 acquires new data and outputs the distinguished result obtained by performing determination by using the learned model. The distinguishing unit 134 receives and acquires, via, for example, the communication unit 110, new data of the distinction target from another terminal. The distinguishing unit 134 generates the integrated data of the distinction target that has been obtained by integrating the acquired new data. The generating unit 131 specifies a complement target record from the generated integrated data.

The distinguishing unit 134 refers to the learned model storage unit 123 and acquires the learned model at the time of the number of replication lines n and n+1 pieces of complement values that are used for determination. The distinguishing unit 134 generates replication data of the distinction target by replicating, based on the acquired n+1 pieces of complement values, n complement target records of the integrated data that is the distinction target and copying each of the n+1 pieces of complement values to the corresponding to complement target records.

The distinguishing unit 134 determines, by using the learned model at the time of acquired number of replication lines n, the replication data of the distinction target. Namely, the distinguishing unit 134 constructs a neural network in which various parameters of the learned models have been set and then sets a method of tensor decomposition. The distinguishing unit 134 performs tensor decomposition on the generated replication data of the distinction target, inputs the replication data to the neural network, and acquires a distinguished result. The distinguishing unit 134 outputs the acquired distinguished result and displays the result on the display unit 111 or outputs the acquired distinguished result and stores the result in the storage unit 120.

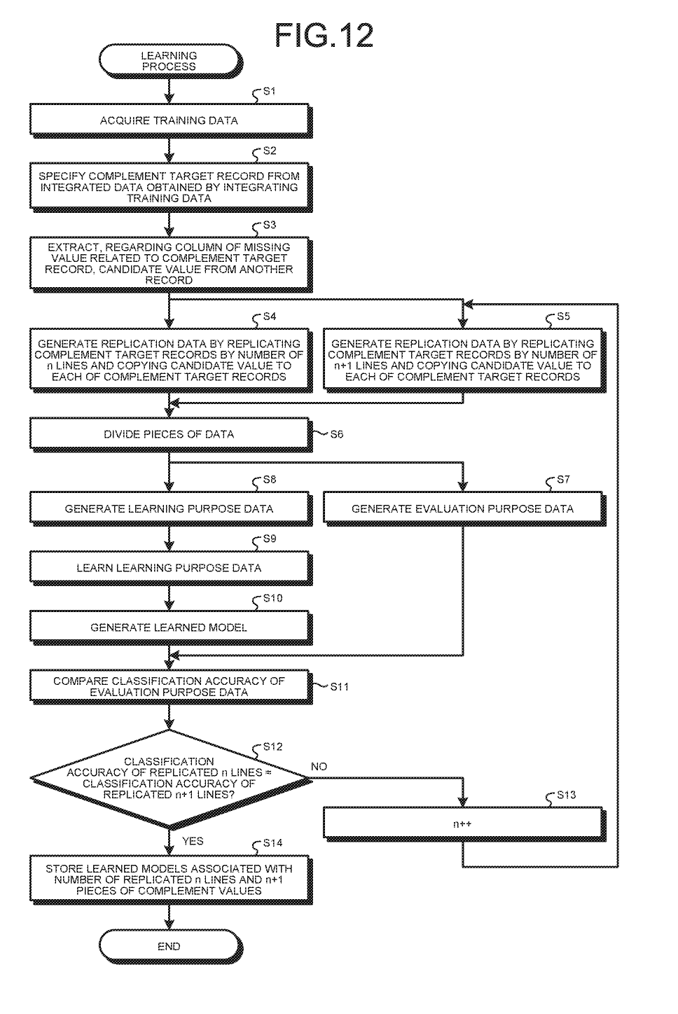

In the following, an operation of the learning device 100 according to the embodiment will be described. First, a learning process for generating a learned model will be described. FIG. 12 is a flowchart illustrating an example of a learning process according to the embodiment.

The generating unit 131 acquires learning purpose training data from, for example, another terminal (Step S1). The generating unit 131 generates integrated data in which the acquired training data has been integrated. The generating unit 131 stores the generated integrated data in the integrated data storage unit 121. The generating unit 131 specifies a complement target record from the generated integrated data (Step S2).

The generating unit 131 extracts, regarding the column of the missing value related to the specified complement target record, a candidate value from another record (Step S3). After having extracted the candidate value, the generating unit 131 generates replication data by replicating the complement target records by the number of n lines and copying a candidate value to each of the complement target records (Step S4). Furthermore, the generating unit 131 generates replication data by replicating the complement target records by the number of n+1 lines and copying the candidate value to each of the complement target records (Step S5). Furthermore, it is possible to set the initial value of n to zero. The generating unit 131 stores the generated replication data in the replication data storage unit 122.

After having generated the replication data, the generating unit 131 divides the generated replication data in order to perform cross-validation (Step S6). The generating unit 131 generated evaluation purpose data that is based on the cross-validation (Step S7). Furthermore, the generating unit 131 generates learning purpose data that is based on the cross-validation (Step S8). The generating unit 131 outputs the generated learning purpose data to the learning unit 132. Furthermore, the generating unit 131 outputs the generated evaluation purpose data to the comparing unit 133.

If the learning purpose data is input from the generating unit 131, the learning unit 132 learns the learning purpose data (Step S9) and generates a learned model (Step S10). Furthermore, the learning unit 132 generates, only the first time, two learned models, i.e., a learned model that is associated with the number of replication lines n and a learned model that is associated with the number of replication lines n+1. After having completed the learning of the learning purpose data, the learning unit 132 stores the learned model in the learned model storage unit 123.

If the learning of the learning purpose data has been completed in the learning unit 132, the comparing unit 133 regards to the learned model storage unit 123 and compares the classification accuracy of the evaluation purpose data by using the evaluation purpose data that has been input from the generating unit 131 (Step S11). The comparing unit 133 determines, based on the result of comparison, whether the classification accuracy of the replicated n lines is substantially the same as the classification accuracy of the replicated n+1 lines (Step S12). If the comparing unit 133 determines that the classification accuracy of the replicated n lines is not substantially the same as the classification accuracy of the replicated n+1 lines (No at Step S12), the comparing unit 133 increments the number of replication lines n (Step S13). Furthermore, the comparing unit 133 instructs the generating unit 131 to generate the subsequent replication data and returns to Step S5.

If the comparing unit 133 the classification accuracy of the replicated n lines is substantially the same as the classification accuracy of the replicated n+1 lines (Yes at Step S12), the comparing unit 133 stores, in the learned model storage unit 123, the learned models associated with the number of replication lines n and n+1 pieces of complement values (Step S14) and ends the learning process. Consequently, the learning device 100 can suppress the degradation of the distinction accuracy due to the complement. Namely, the learning device 100 can generate a learned model having high generalization

Furthermore, in the example of the learning process, because a description has been given with the assumption that an appropriate combination is present as a complement value, exception handling is not performed at Step S12; however, if the number of candidate values is large, it may also possible to proceed the process a process may also proceed to Step S14 after having performed determination at Step S12 a predetermined number of times. The predetermined number of times can be determined in accordance with, for example, the time needed for the learning process. For example, if it takes one hour to perform the processes at Steps S5 to S12, the amount of processes corresponding to one day, i.e., 24 sets of processes, can be performed. Furthermore, the number of candidate value is great, it may also possible to perform a series of the processes at Steps S5 to S12 several times by using the randomly selected candidate values and use candidate values listed on a higher rank.

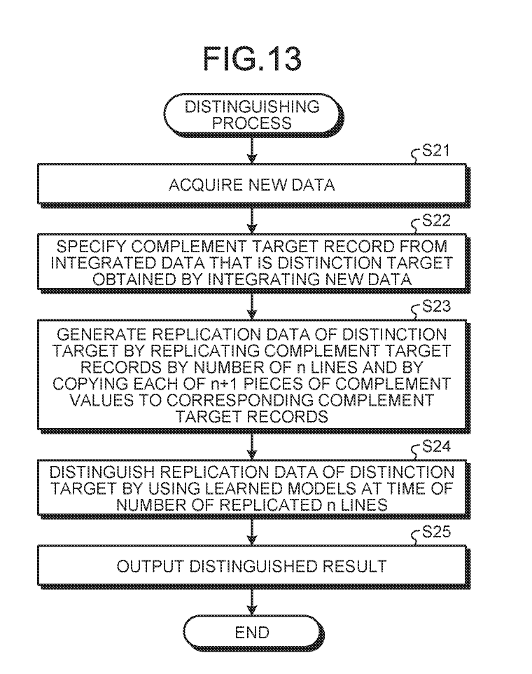

Subsequently, a distinguishing process for distinguishing new data will be described. FIG. 13 is a flowchart illustrating an example of a distinguishing process according to the embodiment.

The distinguishing unit 134 receives and acquires new data of the distinction target from, for example, another terminal (Step S21). The distinguishing unit 134 generates integrated data of the distinction target in which the acquired new data has been integrated. The generating unit 131 specifies a complement target record from the generated integrated data (Step S22).

The distinguishing unit 134 refers to the learned model storage unit 123 and acquires the learned models of the number of replication lines n and n+1 pieces of complement values to be used for the distinction. The distinguishing unit 134 generates the replication data of the distinction target by replicating, based on the acquired n+1 pieces of complement values, n complement target records of the integrated data that is the distinction target and by copying each of the n+1 pieces of complement values to the corresponding complement target records (Step S23).

The distinguishing unit 134 distinguishes the replication data of the distinction target by using the acquired learned models at the time of the number of replication lines n (Step S24). The distinguishing unit 134 outputs the distinguished result to, for example, the display unit 111 and causes the display unit 111 to display the distinguished result (Step S25). Consequently, the learning device 100 distinguishes the data of the distinction target by using the learned model in which the degradation of the distinction accuracy due to the complement has been suppressed, thereby improving, for example, the detection accuracy of an attack of the remote operation. Namely, the learning device 100 can improve the detection accuracy due to an improvement in generalization.

In this way, the learning device 100 inputs input data generated from a plurality of logs in each of which a record that has a plurality of items is used as a unit of data. The learning device 100 generates conversion data by complementing, regarding a complement target record in which one of values in the items of the input data has been lost, at least one of the lost values by a candidate value. Furthermore, the learning device 100 allows learning machine, which performs deep learning by performing tensor decomposition on input tensor data, to learn conversion data. Consequently, the learning device 100 can suppress the degradation of the distinction accuracy due to the complement.

Furthermore, the learning device 100 generates the conversion data complemented by using, as the candidate values, in the item in which the value of the complement target record has been lost, values having a plurality of types included in records, in each of which a value of the same item is not lost, and by copying one of the values from among the candidate values. Consequently, the learning device 100 can perform the learning by complementing the lost value.

Furthermore, the learning device 100 generates the conversion data by arranging the plurality of records including the complement target record in time order, by replicating the complement target records by the number of complement target records that are insufficient for the number of the candidate values, and by copying each of the candidate values to the associated complement target records. Consequently, the learning device 100 can perform the complement in the order in which the candidate values that are expected to have a high relationship.

Furthermore, the learning device 100 generates the conversion data by sequentially copying each of the candidate values to the associated complement target records, in the order in which, from among the items in each of which the value of the complement target record is not lost, the number of items in each of which the value is matched with the item associated with the record that has the candidate value. Consequently, the learning device 100 can sequentially perform the complement in the order of the candidate values that are expected to have a higher relationship.

Furthermore, the learning device 100 generates the conversion data by sequentially copying each of the candidate values to the associated complement target records in the order of the most recent time. Consequently, the learning device 100 can sequentially perform the complement by using the candidate values starting from the candidate value that is expected to be a higher relationship. Namely, the learning device 100 can learn data associated with, for example, an appropriate establishment action close to a command. Namely, the learning device 100 can generate a learned model having high generalization.

Furthermore, the learning device 100 generates, from among the generated pieces of the conversion data, a first learned model that has learned the conversion data obtained by replicating the complement target records by the number of n lines and complementing the candidate values and a second learned model that has learned the conversion data obtained by replicating the complement target records by the number of n+1 lines and complementing the candidate values. Furthermore, the learning device 100 uses the evaluation purpose data that is based on the generated conversion data and compares the classification accuracy of the first learned model with the classification accuracy of the second learned model. Furthermore, the learning device 100 outputs the first learned model and n+1 pieces of complement values that have been complemented into the complement target record in a case where the n is increased until the compared pieces of classification accuracy become equal. Consequently, the learning device 100 can prevent over learning while maximizing the classification accuracy of detection. Furthermore, the learning device 100 can try to reduce calculation time in the learning.

Furthermore, the learning device 100 generates the conversion data by setting, as the candidate values, in the item in which the value of the complement target record has been lost, set values that have a plurality of types and that are previously set and by copying one of the values from among the candidate values. Consequently, the learning device 100 can try to reduce calculation time in the learning.

Furthermore, in the embodiment described above, as a neural network, an RNN is described as an example; however, the neural network is not limited to this. For example, various neural networks, such as a convolutional neural network (CNN), may also be used. Furthermore, also regarding a method of learning, various known methods may also be used other than the error back-propagation method. Furthermore, the neural network has a multilevel structure formed by, for example, an input layer, an intermediate layer (hidden layer), and an output layer and each of the layers has the structure in which a plurality of nodes are connected by edges. Each of the layers has a function called an “activation function”; an edge has a “weight”; and a value of each of the nodes is calculated from a value of the node in a previous layer, a value of the weight of a connection edge, and the activation function held by the layer. Furthermore, various known methods can be used for the calculation method. Furthermore, as the machine learning, in addition to the neural network, various methods, such as a support vector machine (SVM), may also be used.

Furthermore, the components of each unit illustrated in the drawings are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the generating unit 131 and the learning unit 132 may also be integrated. Furthermore, each of the process illustrated in the drawings is not limited to the order described above and may also be simultaneously performed or may also be performed by changing the order of the processes as long as the processes do not conflict with each other.

Furthermore, all or any part of various processing functions performed by each unit may also be executed by a CPU (or a microcomputer, such as an MPU, a micro controller unit (MCU), or the like). Furthermore, all or any part of various processing functions may also be, of course, executed by programs analyzed and executed by the CPU (or the microcomputer, such as the MPU or the MCU), or executed by hardware by wired logic.

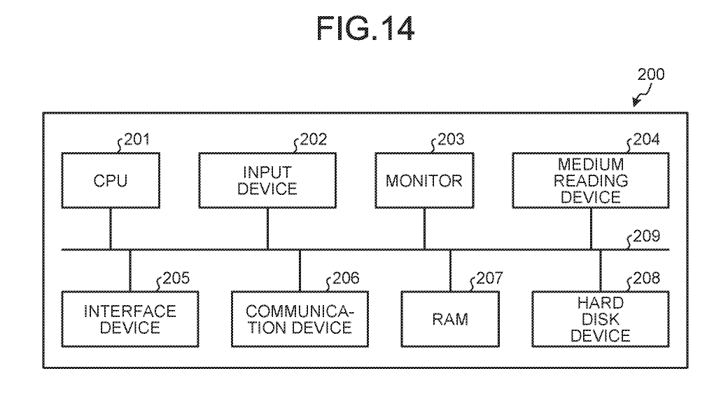

The various processes described in the above embodiment can be implemented by programs prepared in advance and executed by a computer. Accordingly, in the following, an example of a computer that executes programs having the same function as that described in the embodiments described above will be described. FIG. 14 is a diagram illustrating an example of the computer that executes a learning program.

As illustrated in FIG. 14, a computer 200 includes a CPU 201 that executes various kinds arithmetic processing, an input device 202 that receives an input of data, and a monitor 203. Furthermore, the computer 200 includes a medium reading device 204 that reads programs or the like from a storage medium, an interface device 205 that is used to connect various devices, and a communication device 206 that is used to connect to the other information processing apparatuses in a wired or wireless manner. Furthermore, the computer 200 includes a RAM 207 that temporarily stores therein various kinds of information and a hard disk device 208. Furthermore, each of the devices 201 to 208 is connected to a bus 209.

The hard disk device 208 stores therein a learning program having the same function as that performed by each of the processing units, such as the generating unit 131, the learning unit 132, the comparing unit 133, and the distinguishing unit 134, illustrated in FIG. 1. Furthermore, the hard disk device 208 stores therein the integrated data storage unit 121, the replication data storage unit 122, the learned model storage unit 123, and various kinds of data that implements the learning program. The input device 202 receives an input of various kinds of information, such as operation information, from, for example, an administrator of the computer 200. The monitor 203 displays, for example, various screens, such as a display screen, with respect to the administrator of the computer 200. For example, a printer device or the like is connected to the interface device 205. The communication device 206 has the same function as that performed by, for example, the communication unit 110 illustrated in FIG. 1, is connected to a network (not illustrated), and sends and receives various kinds of information to and from the other information processing apparatuses.

The CPU 201 reads each of the programs stored in the hard disk device 208 and loads and executes the programs in the RAM 207, thereby executing various kinds of processing. Furthermore, these programs can allow the computer 200 to function as the generating unit 131, the learning unit 132, the comparing unit 133, and the distinguishing unit 134 illustrated in FIG. 1.

Furthermore, the learning program described above does not always need to be stored in the hard disk device 208. For example, the computer 200 may also read and execute the program stored in a storage medium that can be read by the computer 200. Examples of the computer 200 readable storage medium include a portable recording medium, such as a CD-ROM, a digital versatile disc (DVD), a universal serial bus (USB) memory, or the like, a semiconductor memory, such as a flash memory or the like, and a hard disk drive. Furthermore, the learning program may also be stored in a device connected to a public circuit, the Internet, a LAN, or the like and the computer 200 may also read and execute the learning program from the recording medium described above.

It is possible to suppress the degradation of the distinction accuracy due to the complement.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
inputting input data generated from a plurality of logs, the input data including one or more records that have a plurality of items;
generating conversion data by complementing, regarding a target record, included in the input data, in which one or more values in the plurality of items has been lost, at least one of the one or more lost values by a candidate value; and
causing a learner to execute a learning process using the conversion data as input tensor, the learner performing deep learning by performing tensor decomposition on input tensor.

2. The non-transitory computer-readable recording according to claim 1, wherein the generating includes generating the conversion data complemented by using, as the candidate values, in the item in which the value of the target record has been lost, values having a plurality of types included in records, in each of which a value of the same item is not lost, and by copying one of the values from among the candidate values.

3. The non-transitory computer-readable recording according to claim 2, wherein the generating includes generating the conversion data by arranging the plurality of records including the target record in time order, by replicating the target records by the number of target records that are insufficient for the number of the candidate values, and by copying each of the candidate values to the associated target records.

4. The non-transitory computer-readable recording according to claim 3, wherein the generating includes generating the conversion data by sequentially copying each of the candidate values to the associated complement target records, in the order in which, from among the items in each of which the value of the target record is not lost, the number of items in each of which the value is matched with the item associated with the record that has the candidate value.

5. The non-transitory computer-readable recording according to claim 3, wherein the generating includes generating the conversion data by sequentially copying each of the candidate values to the associated target records in the order of the most recent time.

6. The non-transitory computer-readable recording according to claim 3, wherein the learning process includes
generating, from among the generated pieces of the conversion data, a first learned model that has learned the conversion data obtained by replicating the complement target records by the number of n lines and complementing the candidate values and a second learned model that has learned the conversion data obtained by replicating the complement target records by the number of n+1 lines and complementing the candidate values,
comparing, by using evaluation purpose data that is based on the generated conversion data, classification accuracy of the first learned model with classification accuracy of the second learned model, and
outputting the first learned model and n+1 pieces of complement values that have been complemented into the target record in a case where the n is increased until the compared pieces of classification accuracy become equal.

7. The non-transitory computer-readable recording according to claim 1, wherein the generating includes generating the conversion data by using, as the candidate values, in the item in which the value of the target record has been lost, set values that have a plurality of types and that are previously set and by copying one of the values from among the candidate values.

8. A learning method comprising:
inputting input data generated from a plurality of logs, the input data including one or more records that have a plurality of items, using a processor;
generating conversion data by complementing, regarding a target record, included in the input data, in which one or more values in the plurality of items has been lost, at least one of the one or more lost values by a candidate value, using the processor; and
causing a learner to execute a learning process using the conversion data as input tensor, the learner performing deep learning by performing tensor decomposition on input tensor, using the processor.

9. A learning device comprising:
a memory; and
a processor coupled to the memory, wherein the processor executes a process comprising:
inputting input data generated from a plurality of logs, the input data including one or more records that have a plurality of items;
generating conversion data by complementing, regarding a target record, included in the input data, in which one or more values in the plurality of items has been lost, at least one of the one or more lost values by a candidate value; and
causing a learner to execute a learning process using the conversion data as input tensor, the learner performing deep learning by performing tensor decomposition on input tensor.
